(19) United States
(12) Patent Application Publication
(10) Pub. No.: US 2026/0163829 A1
(43) Pub. Date: Jun. 11, 2026

(54) METHOD FOR CHECKING THE RELIABILITY OF A FIRST VALUE OF A FLOW CONTROL PARAMETER RELATING TO A CONNECTION INTENDED TO BE ESTABLISHED BETWEEN A FIRST ITEM OF COMMUNICATION EQUIPMENT AND A SECOND ITEM OF COMMUNICATION EQUIPMENT LINKED BY A PATH COMPRISING AT LEAST ONE INTERMEDIATE NODE BY MEANS OF A VALUE OF AN INTERMEDIATE PERFORMANCE PARAMETER DETERMINED BY THE INTERMEDIATE NODE

(71) Applicant: Orange, Issy-Les-Moulineaux (FR)

(72) Inventor: Emile STEPHAN, Chatillon Cedex (FR)

(21) Appl. No.: 18/707,491

(22) PCT Filed: Nov. 3, 2022
(86) PCT No.: PCT/EP2022/080671

§ 371 Date: May 3, 2024

(30) Foreign Application Priority Data
Nov. 5, 2021 (FR) 2111781

(51) Int. Cl. H04L 43/0864; H04L 43/0894; H04L 43/106; H04L 47/40

(52) U.S. Cl. CPC H04L 43/0864; H04L 43/0894; H04L 43/106; H04L 47/40

(57) ABSTRACT

A method allowing improving the cooperation between two items of communication equipment forming the ends of a path including at least one intermediate item of equipment. End-to-end encryption systems are designed to withstand any surveillance or tampering attempt, as no third party can decrypt or alter the data being communicated. This reduction in the cooperation between the items of communication equipment located at the ends of the connection and the intermediate items of equipment negatively impacts the performances of a connection established over the communication path including intermediate items of equipment. The method allows re-establishing the cooperation between items of communication equipment, forming the ends of a connection, with intermediate nodes by calculating an intermediate performance parameter.

### CROSS-REFERENCE TO RELATED APPLICATIONS

This application is filed under 35 U.S.C. § 371 as the U.S. National phase of Application No. PCT/EP2022/080671 entitled “METHOD FOR CHECKING THE RELIABILITY OF A FIRST VALUE OF A FLOW CONTROL PARAMETER RELATING TO A CONNECTION INTENDED TO BE ESTABLISHED BETWEEN A FIRST COMMUNICATION DEVICE AND A SECOND COMMUNICATION DEVICE LINKED BY A PATH COMPRISING AT LEAST ONE INTERMEDIATE NODE BY MEANS OF A VALUE OF AN INTERMEDIATE PERFORMANCE PARAMETER DETERMINED BY THE INTERMEDIATE NODE” and filed Nov. 3, 2022, and which claims priority to FR 2111781 filed Nov. 5, 2021, each of which is incorporated by reference in its entirety.

### BACKGROUND

### Field

The field of the invention is that of data transmission. More specifically, the invention relates to the improvement of the cooperation between two items of communication equipment forming the ends of a path comprising at least one intermediate item of equipment.

### Description of the Related Technology

End-to-end encryption (in English, End-to-end encryption or E2EE) is a technique used in communication systems where only the items of communication equipment having established a connection therebetween can access the content of some data transmitted by means of the connection, the data useful for routing could be unencrypted.

End-to-end encryption systems are designed to withstand any attempt to monitor or alter the data, since no third parties can decrypt, and therefore access the data thus communicated if it does not have the security keys used for encryption and decryption.

Thus, the content of the messages transmitted to the receiver communication equipment is encrypted locally by the emitter communication equipment even before the messages are sent throughout the connection, established over a communication path comprising intermediate items of equipment. These intermediate items of equipment, for example of the “middlebox” type, only relay the encrypted messages, based on the unencrypted routing data, and it is the receiver communication equipment which decrypts the message. Thus, the transaction is secure independently of the intermediate equipment which, in turn, could be compromised. End-to-end encryption has become a practice that is increasingly generalised over the Internet.

The evolution of the protocols forming the Web service protocol stack, and more particularly the evolution of the transport layer of the OSI (Open Systems Interconnection) model of this protocol stack, adds to that. The conjunction of these two phenomena contributes to reducing the cooperation between the items of communication equipment located at the ends of the connection and the intermediate items of equipment or “middlebox”. One example of such a protocol is the protocol of the transport layer QUIC (Quick UDP Internet Connections), standardised at the IETF (Internet Engineering Task Force) in RFC9000 which is increasingly used in communication networks.

This reduction in the cooperation between the items of communication equipment located at the ends of the connection and the intermediate items of equipment negatively impacts the performances of a connection established over the communication path comprising intermediate items of equipment.

In a first example, the reduction in the cooperation between the items of communication equipment located at the ends of the connection and the intermediate items of equipment impacts the processing of the retransmission of lost data packets.

Indeed, two mechanisms for retransmission of the lost data coexist: a so-called end-to-end retransmission mechanism implemented by either one of the items of communication equipment and a local mechanism implemented by one of the intermediate items of equipment. In the absence of cooperation between the items of communication equipment located at the ends of the connection and the intermediate items of equipment, these two retransmission mechanisms compete with one another thereby increasing the risks of overburdening the connection yet without guaranteeing the proper retransmission of the lost data packets.

In a second example, the reduction in the cooperation between the items of communication equipment located at the ends of the connection and the intermediate items of equipment impacts the establishment of the connection between the two items of communication equipment forming the ends of the connection to be established.

Indeed, in a context where one of the ends of the connection could be orchestrated by a competitor, it is difficult to determine reliable values of bitrate and bandwidth for the connection to be established.

There is therefore a need for a technique of cooperation between the different items of equipment belonging to the same path allowing reducing the effects of the aforementioned drawbacks.

### SUMMARY

The invention addresses this need by providing a method for determining at least one value of an intermediate performance parameter of a path established between a first item of communication equipment and a second item of communication equipment.

Such a method is particular in that it is executed by at least one intermediate node belonging to said path and that it comprises the following steps:
intercepting at least one first data packet emitted by the first item of communication equipment comprising a first value of a latency parameter,
intercepting at least one second data packet emitted by the second item of communication equipment in response to the reception of the first data packet, the second data packet comprising the first value of the latency parameter,
intercepting at least one third data packet emitted by the first item of communication equipment comprising a second value of a latency parameter,
determining a first round-trip propagation duration between the first item of communication equipment and the intermediate node by means of the first value of the latency parameter, the second value of the latency parameter and timestamp data relating to the first and third data packets,
determining a second round-trip propagation duration between the intermediate node and the second item of communication equipment by means of the first value and timestamp data relating to the first and second data packets,
obtaining a value of the intermediate performance parameter, said value of the intermediate performance parameter corresponding to a ratio between the first round-trip propagation duration and the second round-trip propagation duration
transmitting said value of the intermediate performance parameter to at least one amongst the two items of communication equipment.

The determination of this intermediate performance parameter allows improving the cooperation between the different items of equipment and nodes belonging to the same path by supplying all or some of these items of equipment with information relating to an intermediate performance of a connection established over the considered path. The knowledge of this intermediate performance information allows improving, inter alia, the management of the retransmissions of lost data packets and the management of the establishment of the connection with realistic parameters.

This method is based, in part, on the implementation of a so-called SpinBit mechanism also being standardised at the IETF. The SpinBit mechanism has been proposed in the context of connections established in accordance with the QUIC protocol in order to enable a cooperation between the two items of equipment forming the ends of the path. This mechanism consists in introducing a first value of a latency parameter, for example “0”, if it is encoded over one bit, in a header field of a first data packet QUIC emitted by a first item of communication equipment, this header field not being encrypted. In response to the reception of this first data packet, the second end item of equipment emits a second data packet QUIC comprising the same value of the latency parameter. Upon reception of the second data packet, the first item of communication equipment emits a third data packet comprising a value of the latency parameter different from the first one in a header field, for example “1” if this parameter is encoded over one bit.

An intermediate node intercepting the first, second and third data packets QUIC can, thanks to the two values of the latency parameter and to timestamp data associated with the three data packets, determine a first round-trip propagation duration between the first item of communication equipment and the intermediate node and a second round-trip propagation duration between the intermediate node and the second item of communication equipment. Afterwards, the intermediate node transmits the first duration to the first item of communication equipment and the second duration to the second item of communication equipment.

Afterwards, a ratio of the first duration to the second duration is determined. The value of this ratio implicitly indicates the distance separating the intermediate node from each of the two ends of the path.

This knowledge relating to the path and to the nodes interspersed over the latter enables the ends to adapt some processing that they are brought to implement.

In one example, a transmission frequency of a value of the intermediate performance parameter is determined according to at least one first transmission rule.

This first transmission rule belongs to the group comprising:
one-time transmission of a unique value of the intermediate performance parameter,
transmission at each detection of a modification of a value of the latency parameter of a new value of the intermediate performance parameter,
transmission of a current value of the intermediate performance parameter when it differs from a value of the intermediate performance parameter calculated before.

In order to optimise the use of the resources of the intermediate node, the calculation and the transmission to the ends of a new value of the intermediate performance parameter is modulated by means of these different rules.

In one example, at least one item of communication equipment to which the value of the intermediate performance parameter is transmitted, is identified according to at least one second transmission rule.

This second transmission rule belongs to the group comprising:
transmission of the value of the intermediate performance parameter to the first item of equipment when said value of the intermediate performance parameter is lower than a first threshold,
transmission of the value of the intermediate performance parameter to the second item of equipment when said value of the intermediate performance parameter is higher than a second threshold higher than the first threshold,
transmission to the first item of communication equipment and to the second item of communication equipment when the value of the intermediate performance parameter is comprised between the first threshold and the second threshold,
no transmission of the value of the intermediate performance parameter when the intermediate node executes a number of functions greater than or equal to a third threshold.

Depending on the value of the intermediate parameter, it might be judicious to transmit the latter to either one of the ends of the path in order not to saturate the connection with messages whose content will not be exploited by the receiver equipment of the message.

The invention also relates to a method for managing a retransmission of data exchanged over a path established between a first item of communication equipment and a second item of communication equipment, said path comprising at least one intermediate item of equipment capable of retransmitting at least part of the missing data.

Such a method is particular in that it is implemented by the first item of communication equipment and that it comprises the following steps:
receiving a value of an intermediate performance parameter corresponding to a ratio, determined by said intermediate node, between a first round-trip propagation duration between the first item of communication equipment and the intermediate node and a second round-trip propagation duration between the intermediate node and the second item of communication equipment, the first duration and the second duration also being determined by said intermediate node,
detecting missing data from among the data exchanged with the second item of communication equipment,
selecting a mode of retransmission of said missing data, depending on said value of the intermediate performance parameter.

The use of the intermediate performance parameter enables the item of communication equipment to determine from among the so-called end-to-end retransmission mechanism and the local mechanism, such as a HARQ mechanism (Hybrid Automatic Repeat Request) implemented by the intermediate node that is the most capable, in some cases, of offering the fastest and most efficient retransmission of the lost data.

Thus, when the first item of communication equipment receives data emitted by the second item of communication equipment and when the value of the intermediate performance parameter is lower than a threshold, the mode of retransmission of said missing data consists in delaying an emission to the second item of equipment of a message requesting a retransmission of the missing data, the delay amounting to a third duration longer than or equal to the first round-trip propagation duration.

Indeed, in such a case, the intermediate node being closer (temporarily speaking) to the first item of communication equipment than to the second item of communication equipment it is more responsive and the missing data can be received by the first item of communication equipment via the local retransmission mechanism. In order not to overburden the connection and not to use resources unnecessarily at the second item of communication equipment the first item of communication equipment delays the emission of a request message for retransmission of the missing data to the second item of communication equipment.

Conversely, once the third duration has elapsed and the missing data emitted by the intermediate node have not been received, the first item of communication equipment emits said message requesting a retransmission of the missing data to the second equipment.

In another example, when the first item of communication equipment emits data to the second item of communication equipment and when the value of the intermediate performance parameter is higher than said threshold, the mode of retransmission of said missing data consists in delaying the retransmission of said missing data to the first item of communication equipment, the delay amounting to a fourth duration longer than or equal to the first round-trip propagation duration.

Indeed, in such a case, the intermediate node being closer to the second item of communication equipment than to the second item of communication equipment it is more interesting to delay the retransmission of the missing data in order to leave time to the local retransmission mechanism to execute.

The invention also relates to a method for checking the reliability of a first value of a flow control parameter relating to a connection intended to be established between a first item of communication equipment and a second item of communication equipment connected by a path comprising at least one intermediate node.

Such a method is implemented by the first item of communication equipment and comprises the following steps:
receiving a value of an intermediate performance parameter corresponding to a ratio, determined by said intermediate node, between a first round-trip propagation duration between the first item of communication equipment and the intermediate node and a second round-trip propagation duration between the intermediate node and the second item of communication equipment,
obtaining a target value of a reception bitrate of said connection and of the first value of the flow control parameter,
determining a second value of the flow control parameter by means of the value of the intermediate performance parameter and a value of said first duration,
comparing the first value of the flow control parameter with the second value of the flow control parameter,
when the difference between the first value of the flow control parameter and the second value of the flow control parameter is less than or equal to a threshold, determining a value of the reception bitrate to be used during the establishment of said connection by means of said value of an intermediate performance parameter, and transmitting the value of the reception bitrate to the second item of communication equipment.

The present solution proposes checking the reliability of flow control parameters used upon start-up of a connection established over the path by means of a value of the intermediate performance parameter. Indeed, flow control parameter values intended to be used are supplied at the ends of the path, however these values are not always suited to the reality of the connection, which might result in inconveniences such as the occurrence of congestions.

Thus, if the value of the flow control parameter supplied to one of the ends of the path is reliable, i.e. it corresponds to the value of the flow control parameter calculated by means of the value of the performance parameter then the connection can start up without any risk on the basis of these supplied values.

In one example, the flow control parameter is the product of the target reception bitrate by a round-trip propagation duration between the first item of communication equipment and the second item of communication equipment.

In another example, the first duration and the second duration are determined by the intermediate node using a latency parameter.

In a last example, the value of the reception bitrate is the result of a ratio between the target reception bitrate on the one hand and the result of the difference between 1 and the value of the intermediate performance parameter on the other hand.

Another object of the invention is an intermediate node of a path established between a first item of communication equipment and a second item of communication equipment capable of determining at least one value of an intermediate performance parameter of said path, said intermediate node comprising at least one processor configured to:
intercept at least one first data packet emitted by the first item of communication equipment comprising a first value of a latency parameter,
intercept at least one second data packet emitted by the second item of communication equipment in response to the reception of the first data packet, the second data packet comprising the first value of the latency parameter,
intercept at least one third data packet emitted by the first item of communication equipment comprising a second value of a latency parameter,
determine a first round-trip propagation duration between the first item of communication equipment and the intermediate node by means of the first value of the latency parameter, the second value of the latency parameter and timestamp data relating to the first and third data packets,
determine a second round-trip propagation duration between the intermediate node and the second item of communication equipment by means of the first value and timestamp data relating to the first and second data packets,
obtain a value of the intermediate performance parameter, said value of the intermediate performance parameter corresponding to a ratio between the first round-trip propagation duration and the second round-trip propagation duration,
transmit said value of the intermediate performance parameter to at least one amongst the two items of communication equipment.

The invention also relates to an item of communication equipment forming a first end of a path established between said item of communication equipment and another item of communication equipment, said path comprising at least one intermediate item of equipment capable of retransmitting at least part of the missing data, said equipment being capable of managing a retransmission of data exchanged over the communication path and comprising at least one processor configured to:
receive a value of an intermediate performance parameter corresponding to a ratio, determined by said intermediate node, between a first round-trip propagation duration between the first item of communication equipment and the intermediate node and a second round-trip propagation duration between the intermediate node and the second item of communication equipment the first duration and the second duration being also determined by said intermediate node,
detect missing data from among the data exchanged with the second item of communication equipment,
select a mode of retransmission of said missing data, depending on said value of the intermediate performance parameter.

Another object of the present invention relates to an item of communication equipment forming a first end of a path established between said item of communication equipment and another item of communication equipment, said path comprising at least one intermediate item of equipment capable of retransmitting at least part of the missing data, said item of equipment being capable of checking the reliability of a first value of a flow control parameter relating to a connection intended to be established over the path, and comprising at least one processor configured to:
receive a value of an intermediate performance parameter corresponding to a ratio, determined by said intermediate node, between a first round-trip propagation duration between the first item of communication equipment and the intermediate node and a second round-trip propagation duration between the intermediate node and the second item of communication equipment the first duration and the second duration being also determined by said intermediate node,
obtain a target value of a reception bitrate of said connection and of the first value of the flow control parameter,
determine a second value of the flow control parameter by means of the value of the intermediate performance parameter and of said first duration knowing that said flow control parameter corresponds to the product of the target reception bitrate by a round-trip propagation duration between the first item of communication equipment and the second item of communication equipment,
compare the first value of the flow control parameter with the second value of the flow control parameter,
when the first value of the flow control parameter corresponds to the second value of the flow control parameter, determine a value of the reception bitrate to be used during the establishment of said connection by means of said value of an intermediate performance parameter.

Finally, the invention relates to computer program products comprising program code instructions for implementing the methods as described before, when they are executed by a processor.

The invention also relates to a computer-readable recording medium on which computer programs are recorded comprising program code instructions for the execution of the steps of the methods according to the invention as described hereinabove.

Such a recording medium may be any entity or device capable of storing the programs. For example, the medium may include a storage means, such as a ROM, for example a CD ROM or a microelectronic circuit ROM, or else a magnetic recording means, for example a flash drive or a hard disk.

On the other hand, such a recording medium may be a transmissible medium such as an electrical or optical signal, which may be routed via an electrical or optical cable, by radio or by other means, so that the computer programs contained therein can be executed remotely. In particular, the programs according to the invention may be downloaded over a network, for example the Internet network.

Alternatively, the recording medium may be an integrated circuit in which the programs are incorporated, the circuit being adapted to execute or to be used in the execution of the aforementioned methods objects of the invention.

### BRIEF DESCRIPTION OF THE DRAWINGS

Other aims, features and advantages of the invention will appear more clearly upon reading the following description, given as a simple illustrative and non-limiting example, with reference to the figures, wherein:

FIG. 1: this figure illustrates a system in which the methods object of the invention are implemented,

FIG. 2: this figure illustrates the different steps implemented by the different elements of the system 1 during the execution of a method for determining at least one value of an intermediate performance parameter of the path,

FIG. 3: this figure illustrates the different steps implemented by the different elements of the system 1 during the execution of a method for managing a retransmission of data exchanged over the path,

FIG. 4: this figure illustrates the different steps implemented by the different elements of the system 1 during the execution of a method for checking the reliability of a first value of a flow control parameter relating to a connection intended to be established over the path,

FIG. 5: this figure schematically illustrates an intermediate node,

FIG. 6: this figure schematically illustrates a item of communication equipment.

### DETAILED DESCRIPTION OF CERTAIN ILLUSTRATIVE EMBODIMENTS

The general principle of the invention is based on the determination and the transmission, by an intermediate node of a path established between two items of communication equipment, of a value of an intermediate performance parameter relating to a connection established over this path. Such an intermediate performance parameter allows improving the cooperation between the different items of equipment and nodes belonging to the same path by supplying to all or some of these items of equipment information relating to an intermediate performance of a connection established over the considered path. The knowledge of this intermediate performance information allows improving, inter alia, the management of the retransmissions of lost data packets and the management of the establishment of the connection with realistic parameters.

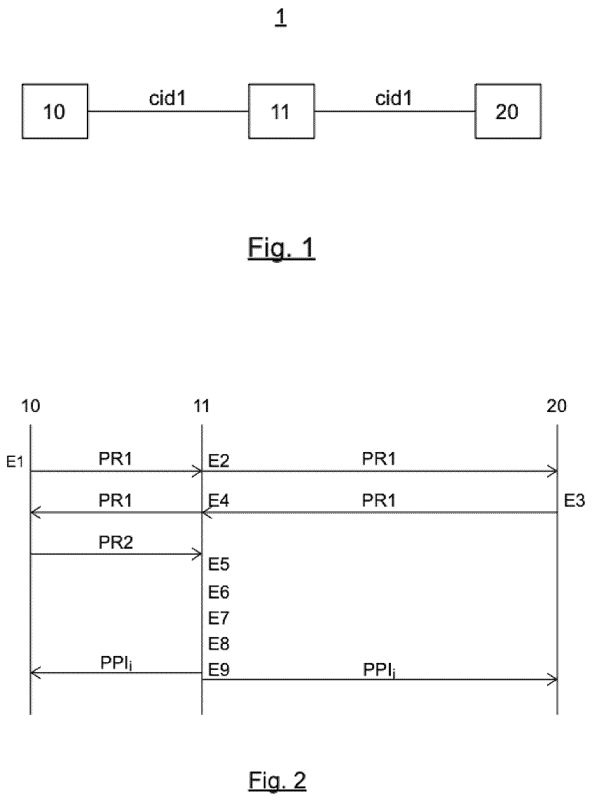

FIG. 1 illustrates a system 1 in which the methods objects of the invention are implemented.

The system 1 comprises at least one first item of communication equipment 10, such an item of communication equipment 10 is for example a home gateway such as a LiveBox®, a “smartphone” type mobile phone, an IoT terminal, a connected car, a digital decoder or “Set Top Box”, etc.

The system 1 comprises at least one intermediate node 11 located in a communication network. For example, such an intermediate node 11 is an element of a mobile network (MEC (Mobile Edge Computing), C-RANs (Cloud Radio Access Networks)), a router, a gateway provided with transport functions or application functions, or a proxy. The intermediate node 11 hosts one or more transmission function(s).

Finally, the system 1 comprises a second item of communication equipment 20 such as a server for example.

A communication path cid1, throughout which data are intended to be transmitted, is established or is being established between the first item of communication equipment 10 and the second item of communication equipment 20. This communication path cid1 is established throughout one or more intermediate node(s) including the intermediate node 11.

Such a communication path cid1 being established between the first item of communication equipment 10 and the second item of communication equipment 20, only these two items of communication equipment 10, 20 can access the content of the data transmitted over the path cid1. Thus, the intermediate node 11 does not access the data transmitted throughout the path cid1, it contends with transmitting them to the next item of equipment, or another intermediate node, or the second item of communication equipment 20. It should be understood that some so-called routing data like the destination address, are accessible to the intermediate items of equipment to route the data but not the data included, for example, in transport or application layer fields of the messages.

FIG. 2 illustrates the different steps implemented by the different elements of the system 1 during the execution of a method for determining at least one value of an intermediate performance parameter PPI of the path cid1.

In a step E1, the item of communication equipment 10 emits a first data packet comprising, at the header, a first value of a latency parameter PL1 in accordance with the mechanism SpinBit described in the document referenced as “Adding Explicit Passive Measurability of Two-Way Latency to the QUIC Transport Protocol draft-trammell-quic-spin-03” and published by the IETF on Nov. 15, 2018. In one example, the first value PL1 of the latency parameter is 0.

The intermediate node 11 intercepts this first data packet, and timestamps and records the first value PL1 of the latency parameter before transferring the data packet to the second item of communication equipment 20 in a step E2.

In response to the reception of the first data packet, the second item of communication equipment 20 emits, in a step E3, a data packet to the first item of communication equipment 10 comprising, at the header, the first value of the latency parameter PL1.

The intermediate node 11 intercepts this second data packet, and timestamps and stores the first value PL1 of the latency parameter extracted from this second data packet before transferring the data packet to the first item of communication equipment 10 in a step E4.

In a step E5, upon reception of the second data packet, the first item of communication equipment 10 emits a third one comprising at the header a second value PL2 of the latency parameter distinct from the first value PL1. In one example, the second value PL2 of the latency parameter is 1.

The intermediate node 11 intercepts this third data packet, and timestamps and stores the second value PL2 of the latency parameter before transferring the data packet to the second item of communication equipment 20 in a step E6. Thanks to this exchange of data packets, the item of communication equipment 10 and the item of communication equipment 20 can determine a round-trip propagation duration RTT between the first item of communication equipment 10 and the second item of communication equipment 20, if this is not done using acknowledgement packets.

In a step E7, the intermediate node 11 determines a first round-trip propagation duration RTT1011 between the first item of communication equipment 10 and the intermediate node 11, and a second round-trip propagation duration RTT1120 between the intermediate node 11 and the second item of communication equipment 20, by means of the timestamp data associated with the different values of the recorded latency parameter PL1 and PL2.

For example, the round-trip propagation duration RTT1120 between the intermediate node 11 and the second item of communication equipment 20 is obtained thanks to the timestamps of the output of the first data packet and of the arrival of the second packet data in the intermediate item of equipment 11.

In turn, the round-trip propagation duration RTT1011 between the first item of communication equipment 10 and the intermediate node 11 is obtained thanks to the timestamps of the input of the second data packet and of the output of the third packet data in the intermediate item of equipment 11.

Afterwards, the intermediate node 11 determines, during a step E8, a value of an intermediate performance parameter PPI. The intermediate performance parameter PPI is the ratio between the first round-trip propagation duration RTT1011 and the second round-trip propagation duration RTT1120:

$$PPI = \frac{RTT 1011}{RTT 1120}$$

A transmission frequency of a value of the intermediate performance parameter PPI is determined by the intermediate node 11 according to at least one first transmission rule RT1.

Such a transmission rule RT1 belongs to the group comprising:
one-time transmission of a unique value of the intermediate performance parameter PPI,
transmission at each detection of a modification of a value of the latency parameter of a new value of the intermediate performance parameter,
transmission of a current value of the intermediate performance parameter when it differs from a value of the intermediate performance parameter calculated before.

Thus, in a first example, the intermediate node 11 may have as an instruction to calculate and transmit only one single value of the intermediate performance parameter PPI.

In a second example, the intermediate node 11 may have as an instruction to transmit over time several values PPI1 to PPPN of the intermediate performance parameter. The transmission of these different values PPI1 to PPPN of the intermediate performance parameter being triggered by different events.

Similarly, the item of communication equipment to which a value of the intermediate performance parameter PPI should be transmitted is identified according to at least one second transmission rule RT2.

Such a transmission rule RT2 belongs to the group comprising:
transmission of the value of the intermediate performance parameter PPI to the first item of communication equipment 10 when the value of the intermediate performance parameter P1 is lower than a first threshold S1,
transmission of the value of the intermediate performance parameter PPI to the second item of communication equipment 20 when said value of the intermediate performance parameter PPI is higher than a second threshold S2 higher than the first threshold S1,
transmission to the first item of communication equipment 10 and to the second item of communication equipment 20 when the value of the intermediate performance parameter PPI is comprised between the threshold S1 and the threshold S2,
no transmission of the value of the intermediate performance parameter PPI when the intermediate node 11 executes a number of processes (for example the number of retransmissions) greater than or equal to a third threshold S3.

In one example, the threshold S1 is set at 0.4. If the value PPI of the intermediate performance parameter amounts to ⅓, then this means that the intermediate node 11 is (temporally) closer to the item of communication equipment 10, the value PPI of the intermediate performance parameter should therefore be transmitted thereto.

In another example, the threshold S2 is set at 0.75. If the value PPI of the intermediate performance parameter amounts to ⅔, then this means that the intermediate node 11 is closer to the item of communication equipment 20, the value PPI of the intermediate performance parameter should therefore be transmitted thereto.

In another example, these are operating data of the intermediate node 11 which can condition the transmission of the value PPI of the intermediate performance parameter. Thus, if the workload, for example the number of processes executed by the intermediate node 11 at the same time point, is greater than the threshold S3 beyond which the intermediate node 11 leaves its rated operating state, then the value PPI of the intermediate performance parameter is not transmitted.

Of course, other transmission rules RT1 and RT2 may be considered in the context of the present solution.

Once the intermediate node 11 has identified the item(s) of communication equipment to which it should transmit a value PPIᵢ of the intermediate performance parameter as well as the transmission frequency, then it proceeds with this transmission during a step E9. In the example illustrated in FIG. 2, the intermediate node 11 transmits the value PPIᵢ of the intermediate performance parameter to the two items of communication equipment 10 and 20.

In order to transmit the value PPIᵢ of the intermediate performance parameter, the intermediate node 11 can encode it and introduce it into a header field of a data packet transiting over the path cid1 to either one of the items of communication equipment 10, 20.

For example, the value PPI of the intermediate performance parameter may be encoded on 2 bits where ‘01’ means that the intermediate node 11 is (temporally speaking) located between the item of communication equipment 10 and the third of the path cid1, ‘11’ means that the intermediate node 11 is located between the third and the 2 thirds of the path cid1 and finally ‘10’ means that the intermediate node 11 is located between the 2 thirds of the path cid1 and the item of communication equipment 20.

Of course, the value PPI of the intermediate performance parameter may be encoded over more than 2 bits.

Finally, such a method may also be applied to paths comprising more than two ends.

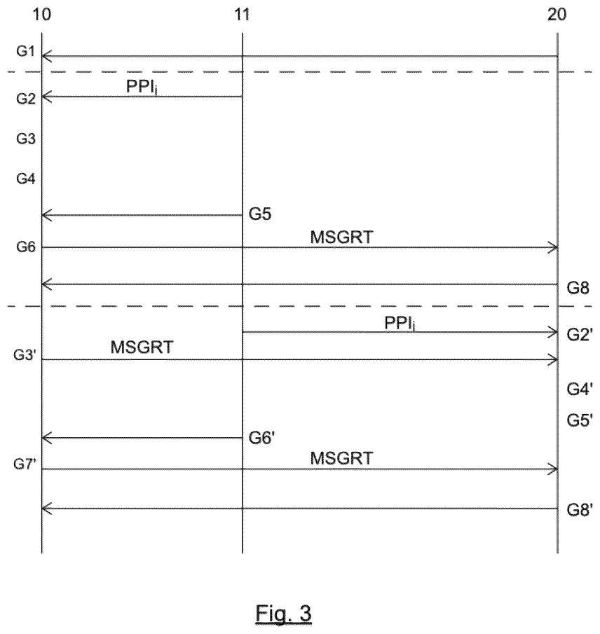

FIG. 3 illustrates the different steps implemented by the different elements of the system 1 during the execution of a method for managing a retransmission of data exchanged over the path cid1.

In the remainder of the description of this method, it will be assumed that the first item of communication equipment 10 receives data emitted by the second item of communication equipment 20. Of course, what is described hereinbelow also applies to the case in which the second item of communication equipment 20 receives data emitted by the first item of communication equipment 10. In this method, the use of the intermediate performance parameter enables a item of communication equipment to determine from among the so-called end-to-end retransmission mechanism and the local mechanism, such as a HARQ mechanism implemented by the intermediate node, which is the most capable of offering the fastest and most efficient retransmission of the lost data.

Thus, in a step G1, the first item of communication equipment 10 detects an anomaly in the data packets received from the second item of communication equipment 20. The detected anomaly may be the loss of a data packet or a portion of a data packet, a data packet received late or the reception of a de-sequenced data packet.

In a first example, the first item of communication equipment 10 receives in a step G2, which may be anterior, posterior or concomitant with step G1, a value PPIᵢ of the intermediate performance parameter obtained by the intermediate node as described with reference to FIG. 2.

In a step G3, the item of communication equipment 10 then compares the value PPIᵢ of the intermediate performance parameter with a threshold S4. Such a threshold S4 may be fixed or dynamic in order to adapt to the changes that might occur on the path cid1 such as a change in hardware, a modification of connection parameters, etc.

When the value PPIᵢ of the intermediate performance parameter is lower than the threshold S4, the item of communication equipment 10 decides to delay the emission, to the second item of communication equipment 20, a message MSGRT requesting a retransmission of the missing data in a step G4. the item of communication equipment 10 delays the emission of the message MSGRT by a duration, so-called retention duration, longer than or equal to the first round-trip propagation duration RTT1011.

This leaves time to the intermediate node 11 to implement the HARQ mechanism and transmit the missing data to the first item of communication equipment 10 in a step G5.

Indeed, when the value PPIᵢ of the intermediate performance parameter is lower than the threshold S4, this means that the intermediate node is (temporally) closer to the first item of communication equipment 10 than to the second item of communication equipment 20. Thus, the intermediate node 11 is more able to retransmit the missing data faster than it would be the case by means of the end-to-end retransmission mechanism.

This delay of the transmission of the message MSGRT to the second item of communication equipment 20 also allows not overburdening the path cid1 and not using resources unnecessarily at the second item of communication equipment 20.

Once the retention duration has elapsed and the missing data supposedly sent by the intermediate node 11 have not been received, the first item of communication equipment 10 emits said message MSGRT requesting the retransmission of the missing data to the second item of communication equipment 20 during a step G6.

Following the reception of this message MSGRT, the item of communication equipment 20 retransmits the missing data to the first item of communication equipment 10 in a step G8.

When the value PPIᵢ of the intermediate performance parameter is higher than the threshold S4, this means that the intermediate node is closer to the second item of communication equipment 20 than to the first item of communication equipment 10. In such a case, the second item of communication equipment 20 is more able to retransmit the missing data than the intermediate node 11. In this case, the first item of communication equipment 10 emits the message MSGRT to the second item of communication equipment 20 without delay.

In a second example, the second item of communication equipment 20 receives in a step G2′ which may be anterior, posterior or concomitant with step G1, a value PPIᵢ of the intermediate performance parameter obtained by the intermediate node as described with reference to FIG. 2.

In a step G3′, the first item of communication equipment 10 emits a message MSGRT requesting a retransmission of the missing data to the second item of communication equipment 20.

Upon reception of the message MSGRT, the item of communication equipment 20 then compares the value PPIᵢ of the intermediate performance parameter with a threshold S5, which may be identical, or not, to the threshold S4 in a step G4′. In turn, such a threshold S5 may also be fixed or dynamic to adapt to the changes that might occur on the path cid1 such as a change in hardware, a modification of connection parameters, etc.

When the value PPIᵢ of the intermediate performance parameter is lower than the threshold S5, the item of communication equipment 20 decides to delay the emission, to the first item of communication equipment 10, of the missing data in a step G5′. The item of communication equipment 20 delays the emission of the missing data by a duration, so-called retention duration, whose value is for example longer than or equal to the sum of the round-trip propagation duration RTT between the first item of communication equipment 10 and the second item of communication equipment 20 with the first round-trip propagation duration RTT1011 between the first item of communication equipment 10 and the intermediate node 11.

This leaves time to the intermediate node 11 to implement the HARQ mechanism and to transmit the missing data to the first item of communication equipment 10 in a step G6′.

Indeed, when the value PPIᵢ of the intermediate performance parameter is lower than the threshold S4, this means that the intermediate node is closer to the first item of communication equipment 10 than to the second equipment. Thus, the intermediate node 11 is more able to retransmit the missing data faster than it would be the case by means of the end-to-end retransmission mechanism.

This delay of the retransmission of the missing data to the first item of communication equipment 10 also allows not overburdening the path cid1 and not using resources unnecessarily at the second item of communication equipment 20.

Once the retention duration has elapsed and the missing data supposedly sent by the intermediate node 11 have not been received, the first item of communication equipment 10 emits a new message MSGRT requesting the retransmission of the missing data to the second item of communication equipment 20 which receives it during a step G7′.

Following the reception of this message MSGRT, the item of communication equipment 20 retransmits the missing data to the first item of communication equipment 10 in a step G8′.

When the value PPIᵢ of the intermediate performance parameter is higher than the threshold S5, this means that the intermediate node is closer to the second item of communication equipment 20 than to the first item of communication equipment 10. In such a case, the second item of communication equipment 20 is more able to retransmit the missing data than the intermediate node 11, it therefore does not implement steps G5′ to G7′. In this example, upon completion of step G4′, the second item of communication equipment 20 directly implements step G8′ of retransmitting the missing data.

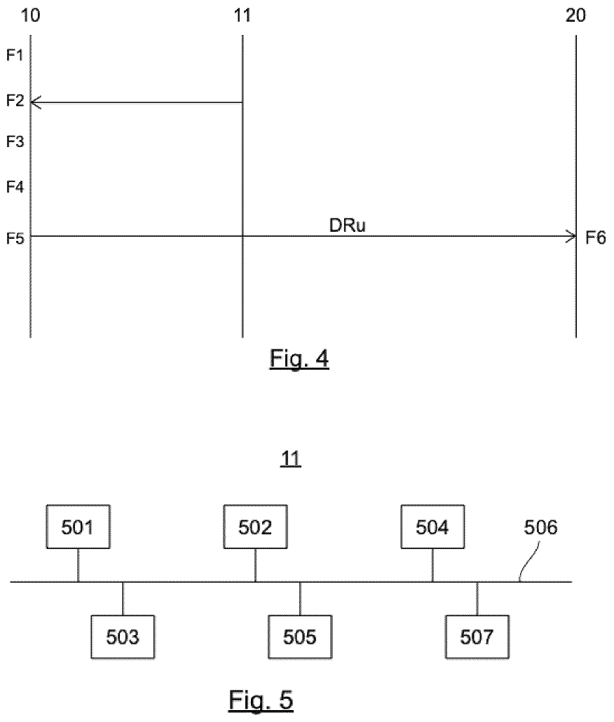

FIG. 4 illustrates the different steps implemented by the different elements of the system 1 during the execution of a method for checking the reliability of a first value of a flow control parameter relating to a connection intended for be established over the path cid1.

In the remainder of the description of this method, it will be assumed that the first item of communication equipment 10 receives data emitted by the second item of communication equipment 20. Of course, what is described hereinbelow also applies to the case in which the second item of communication equipment 20 receives data emitted by the first item of communication equipment 10. In this method, the use of the intermediate performance parameter allows checking whether the value of the flow control parameter supplied at one of the ends of the path cid1 is reliable and thus ensuring the proper start-up or restart of the connection.

During the implementation of a mechanism for starting or restarting a connection established over the path cid1, during a step F1, the first item of communication equipment 10 obtains, inter alia, a target value of a reception bitrate DRc for the connection and a first value of a flow control parameter PCF1. For example, such a flow control parameter PCF1 is a parameter BDP (Bandwidth-Delay Product) enabling the first item of communication equipment 10 to know, upon a start-up or a restart of connection, parameters such as the acceleration of the bitrate in which the second item of communication equipment 20 will transmit the data during the start-up phase of the connection.

The first item of communication equipment 10 also receives in a step F2, which may be anterior, posterior or concomitant with step F1, a value PPIᵢ of the intermediate performance parameter obtained by the intermediate node as described with reference to FIG. 2.

In a step F3, the first item of communication equipment 10 determines a second value PCF2 of the flow control parameter by means, inter alia, of the value PPIᵢ of the intermediate performance parameter and the value of the target reception bitrate DRc, as well as the following calculation formula:

$$PCF 2 = DRc \times RTT$$

$$where RTT = RTT 1011 + RTT 1120.$$

Knowing the propagation time RTT1011, for example following the implementation of the method for determining at least one value of an intermediate performance parameter PPI described with reference to FIG. 2 or because it has received this information during step F1, and the value PPIᵢ of the intermediate performance parameter, the first item of communication equipment 10 is capable of determining, in a first step, a value RTT1120cal of the propagation duration between the intermediate node 11 and the second item of communication equipment 20:

$$RTT 1120 cal = \frac{RTT 1011}{{PPI}_{i}}$$

In a second step, knowing the value of the propagation duration RTT1011 between the first item of communication equipment 10 and the intermediate node 11 and the value of the propagation time RTT1120cal of the propagation time between the intermediate node 11 and the second item of communication equipment 20, the first item of communication equipment 10 determines a value RTTcal of the duration of propagation between the first item of communication equipment 10 and the second equipment communication 20:

$$RTTcal = RTT 1011 + RTT 1120 cal$$

In a third step, the first item of communication equipment 10 determines the second value PCF2 of the flow control parameter by means of the value RTTcal of the duration of propagation between the first item of communication equipment 10 and the second item of communication equipment 20 and of the target value of the reception bitrate DRc:

$$PCF 2 = DRc \times RTTcal$$

In a step F4, the first item of communication equipment 10 compares the first value PCF1 of the flow control parameter with the second value PCF2 of the flow control parameter obtained by means of the intermediate performance parameter PPIᵢ.

When the first value PCF1 of the flow control parameter does not deviate from the second value PCF2 of the flow control parameter by more than a predefined percentage, for example in the range of 10%, the first item of communication equipment 10 determines a value of the reception bitrate to be used DRu during the establishment of the connection by means of said value PPIᵢ of an intermediate performance parameter in a step F5. Otherwise, the default flow control parameters are used.

In one example, the value of the reception bitrate DRu is determined as follows.

$$DRu = \frac{DRc}{1 - {PPI}_{i}}$$

Once the value of the reception bitrate to be used DRu has been determined, it is transmitted to the second item of communication equipment 20, in a step F6, so that the latter adapts its emission bitrate accordingly.

Optionally, the above-described steps F1 to F6 are implemented in parallel in the opposite direction, by the second item of communication equipment 20 in order to determine a value of the reception bitrate to be used Dru that the first item of communication equipment 10 should use when it emits data to the second item of communication equipment 20.

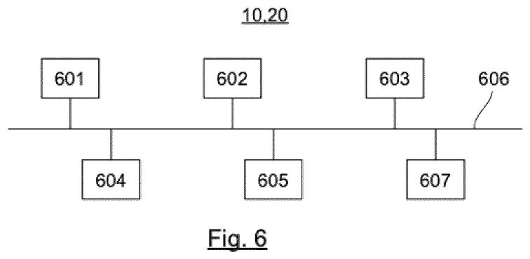

FIG. 5 schematically illustrates an intermediate node 11.

The intermediate node 11 may comprise at least one hardware processor 501, a storage unit 502, an input device 503, a display device 504, an interface unit 505, and a network interface 507 which are connected together throughout a bus 506. Of course, the constituent elements of the intermediate node 11 may be connected by means of a connection other than a bus.

The processor 501 controls the operations of the intermediate node 11. The storage unit 502 stores at least one program for determining at least one value of an intermediate performance parameter PPI of a path cid1 established between a first item of communication equipment 10 and a second item of communication equipment 20, to be executed by the processor 501, and various data, such as parameters used for calculations performed by the processor 501, intermediate data of calculations performed by the processor 501, etc. The processor 501 may be formed by any known and suitable hardware or software, or by a combination of hardware and software. For example, the processor 501 may be formed by a dedicated hardware such as a processing circuit, or by a programmable processing unit such as a central processing unit (Central Processing Unit) which executes a program stored in a memory thereof.

The storage unit 502 may be formed by any suitable means capable of storing the program, and data in a computer-readable manner. Examples of a storage unit 502 include non-transitory computer-readable storage media such as semiconductor memory devices, and magnetic, optical or magneto-optical recording media loaded in a read and write unit. The program makes the processor 401 execute a method for discovering a transmission function according to an embodiment of the invention.

The input device 503 may be formed by a keyboard, a pointing device such as a mouse to be used by a user to enter commands. The display device 504 may be formed by a display device for displaying, such as a graphical user interface (GUI). The input device 503 and the display device 504 may be formed integrally by means of a touchscreen, for example.

The interface unit 505 provides an interface between the intermediate node 11 and an external apparatus. The interface unit 505 can communicate with the external apparatus via a wired or wireless connection. For example, such an external apparatus is a laptop.

A network interface 507 provides a connection between the intermediate node 11 and another intermediate node 11 via a communication network, such as the Internet, or an item of communication equipment 10, 20. Depending on its nature, the network interface 507 can provide a wired or wireless connection to the network.

FIG. 6 schematically illustrates an item of communication equipment 10, 20.

The item of communication equipment 10, 20 may comprise at least one hardware processor 601, a storage unit 602, an input device 603, a display device 604, an interface unit 605, and a network interface 607 which are connected together throughout a bus 606. Of course, the constituent elements of the item of communication equipment 10, 20 may be connected by means of a connection other than a bus.

The processor 601 controls the operations of the item of communication equipment 10, 20. The storage unit 602 stores at least one program for managing a retransmission of data exchanged over a target path cid1 established between the first equipment communication 10 and the second item of communication equipment 20 and/or a program for checking the reliability of a first value of a flow control parameter PCF relating to a connection intended to be established over the path cid1, to be executed by the processor 601, and various data, such as parameters used for calculations performed by the processor 601, intermediate data of calculations performed by the processor 601, etc. The processor 601 may be formed by any known and suitable hardware or software, or by a combination of hardware and software. For example, the processor 601 may be formed by a dedicated hardware such as a processing circuit, or by a programmable processing unit such as a central processing unit (Central Processing Unit) which executes a program stored in a memory thereof.

The storage unit 602 may be formed by any suitable means capable of storing the program, data in a computer-readable manner. Examples of storage unit 602 comprise non-transitory computer-readable storage media such as semiconductor memory devices, and magnetic, optical or magneto-optical recording media loaded in a read and write unit. The program makes the processor 601 execute a method for selecting a path according to an embodiment of the invention.

The input device 603 may be formed by a keyboard, a pointing device such as a mouse to be used by a user to enter commands. The display device 604 may be formed by a display device for displaying, such as a graphical user interface (GUI). The input device 603 and the display device 604 may be formed integrally by means of a touchscreen, for example.

The interface unit 605 provides an interface between the item of communication equipment 10, 20 and an external apparatus. The interface unit 605 can communicate with the external apparatus via a wired or wireless connection. For example, such an external apparatus is a digital decoder or a “smartphone”.

A network interface 607 provides a connection between the item of communication equipment 10, 20 and an intermediate node 11 via a communication network, such as the Internet. Depending on its nature, the network interface 607 can provide a wired or wireless connection to the network.

1. (canceled)

2. (canceled)

3. (canceled)

4. (canceled)

5. (canceled)

6. A method for checking the reliability of a first value of a flow control parameter relating to a connection intended to be established between a first item of communication equipment and a second item of communication equipment connected by a path comprising at least one intermediate node, the method being implemented by the first item of communication equipment and comprising the following:
receiving a value of an intermediate performance parameter corresponding to a ratio, determined by the intermediate node, between a first round-trip propagation duration between the first item of communication equipment and the intermediate node and a second round-trip propagation duration between the intermediate node and the second item of communication equipment, the first round-trip propagation duration being determined by means of a first value of a latency parameter comprised in a first data packet and in a second data packet exchanged between the first item of communication equipment and the second item of communication equipment, a second value of a latency parameter comprised in a third data packet emitted by the first item of communication equipment, and timestamp data relating to the first and third data packets, the second round-trip propagation duration being determined by means of the first value and timestamp data relating to the first and second data packets,
obtaining a target value of a reception bitrate of the connection and of the first value of the flow control parameter,
determining a second value of the flow control parameter by means of the value of the intermediate performance parameter and a value of the first duration,
comparing the first value of the flow control parameter with the second value of the flow control parameter, and
when the difference between the first value of the flow control parameter and the second value of the flow control parameter is less than or equal to a threshold, determining a value of the reception bitrate to be used during the establishment of the connection by means of the value of an intermediate performance parameter, and transmitting the value of the reception bitrate to the second item of communication equipment.

7. The method for checking the reliability of a first value of a flow control parameter according to claim 6, where the flow control parameter is the product of the target reception bitrate by a round-trip propagation duration between the first item of communication equipment and the second item of communication equipment.

8. The method for checking the reliability of a first value of a flow control parameter according to claim 6, where the first duration and the second duration are determined by the intermediate node using a latency parameter.

9. The method for checking the reliability of a first value of a flow control parameter according to claim 6, wherein the value of the reception bitrate is the result of a ratio between the target reception bitrate on the one hand and the result of the difference between 1 and the value of the intermediate performance parameter on the other hand.

10. (canceled)

11. Item of communication equipment forming a first end of a path established between the item of communication equipment and another item of communication equipment, the path comprising at least one intermediate item of equipment capable of retransmitting at least part of the missing data, the equipment being capable of checking the reliability of a first value of a flow control parameter relating to a connection intended to be established over the path, and comprising at least one processor configured to:
receive a value of an intermediate performance parameter corresponding to a ratio, determined by the intermediate node, between a first round-trip propagation duration between the first item of communication equipment and the intermediate node and a second round-trip propagation duration between the intermediate node and the second item of communication equipment, the first duration and the second duration being also determined by the intermediate node, the first round-trip propagation duration being determined by means of a first value of a latency parameter comprised in a first data packet and in a second data packet exchanged between the first item of communication equipment and the second item of communication equipment, a second value of a latency parameter comprised in a third data packet emitted by the first item of communication equipment, and timestamp data relating to the first and third data packets, the second round-trip propagation duration being determined by means of the first value and timestamp data relating to the first and second data packets,
obtain a target value of a reception bitrate of the connection and of the first value of the flow control parameter,
determine a second value of the flow control parameter by means of the value of the intermediate performance parameter and of the first duration knowing that the flow control parameter corresponds to the product of the target reception bitrate by a round-trip propagation duration between the first item of communication equipment and the second item of communication equipment,
compare the first value of the flow control parameter with the second value of the flow control parameter, and
when the first value of the flow control parameter corresponds to the second value of the flow control parameter, determine a value of the reception bitrate to be used during the establishment of the connection by means of the value of an intermediate performance parameter.
